(19) United States
(12) Patent Application Publication
(10) Pub. No.: US 2002/0147418 A1
(43) Pub. Date: Oct. 10, 2002

(54) Massage device

(76) Inventor: Chu Chau Huang, Taipei (TW)

Correspondence Address: CHU CHAU HUANG, P. O. Box 26-757, Taipei, 106, TW

(21) Appl. No.: 09/834,705

(22) Filed: Apr. 9, 2001

(51) Int. Cl. A61H 7/00

(52) U.S. Cl. 601/137; 601/136

(57) ABSTRACT

A massage device includes a housing, a connecting unit and an elastomer. The bottom of the housing is installed with an inner wall. The inner wall is matched to the outer wall of the connecting unit so that the two are coupled. Furthermore, the inner wall of the connecting unit is installed with a trench, and a plurality of though holes are formed, which are communicated with the trench. Thereby, the outer edge of the elastomer is installed in the trench of the connecting unit so that the elastomer protrudes from the bottom of the housing. Glue fills from the though holes so as to achieve a better combination.

### FIELD OF THE INVENTION

The present invention relates to a massage device, and especially to massage device having a firmly secured combining structure and the massage effect of which is improved.

### BACKGROUND OF THE INVENTION

Referring to FIG. 1, the prior massage device 1a includes a holdable rod 10a. The distal end of the rod 10a is installed to the top surface of the housing 11a. The bottom of the housing 11a is installed with a hollow recess 12a. The outer edge of the recess 12a is formed with an annular gluing portion 13a. The inner lateral side of the gluing portion 13a near the recess 12a is stuck to an outer edge of an elastomer 14a by glue (not shown) so that the elastomer 14a may protrude out and adhere to the bottom of the housing 1a. A plurality of apertures 15a spaced arranged are installed on the elastomer 14a. Each aperture 15a is installed with protrusion 16a. By the protrusion 16a, the massage device 1a has the affect of massage.

However, since the elastomer 14a is only stucky to the inner surface of gluing portion 13a by glue (not shown), after being used for a long time, the outer edge of the elastomer 14a is easily separated with the gluing portion 13a due to a press force. Thus the structure is loose. Moreover, in manufacturing the massage device, since the elastomer 14a and the gluing portion 13a are combined by surface contact, too much glue (not shown) will flow out so as to effect the outlook of the product. Furthermore, the combining way of the elastomer 14a and the glue 13a can not enhance the elastomer 14a, thus the massage effect being bad.

### SUMMARY OF THE INVENTION

Accordingly, the primary object of the present invention is to provide a massage device which has a tight structure. The elastomer will not separate with the housing due to a long period of using. Moreover, glue will not flow out so as to sustain a beautiful outlook.

Another object of the present invention is to provide a massage device, wherein the elastomer has a stronger structure so as to present a preferred massage effect.

A further object of the present invention is to provide a massage device which can be assembled easily and conveniently so that the products can be diversified and produced rapidly.

To achieve aforesaid objects, the present invention provides a massage device including a housing, a connecting unit and an elastomer. The bottom of the housing is installed with an inner wall. The inner wall is matched to the outer wall of the connecting unit so that the two are coupled. Furthermore, the inner wall of the connecting unit is installed with a trench, and a plurality of though holes are formed, which are communicated with the trench. Thereby, the outer edge of the elastomer is installed in the trench of the connecting unit so that the elastomer protrudes from the bottom of the housing. Glue fills from the though holes so as to achieve a better combination.

The present invention also provides a massage device, wherein the trench of the connecting unit is formed with an opening, a bending portion is installed at the opening near the inner wall of the connecting unit, and the bending portion is inwards reduced so that the bottom of the inner wall of the connecting unit is bent inwards. The elastomer has a stronger structure so as to present a preferred massage effect.

And the present invention provides a massage device, wherein the bottom of the housing has a hollow recess. The inner wall of the recess is formed with an annular groove. An annular tilt surface is installed on the outer wall of the connecting unit. The tile surface will cause the outer edge of the groove is enlarged gradually along the tilt surface of the connecting unit as the housing and the connecting unit are engaged until the connecting unit is buckled. Therefore, the connecting unit and the housing can be rapidly and conveniently buckled so that the product can be produced rapidly.

### BRIEF DESCRIPTION OF THE DRAWINGS

FIG. 1 is a schematic cross sectional view of a prior massage device.

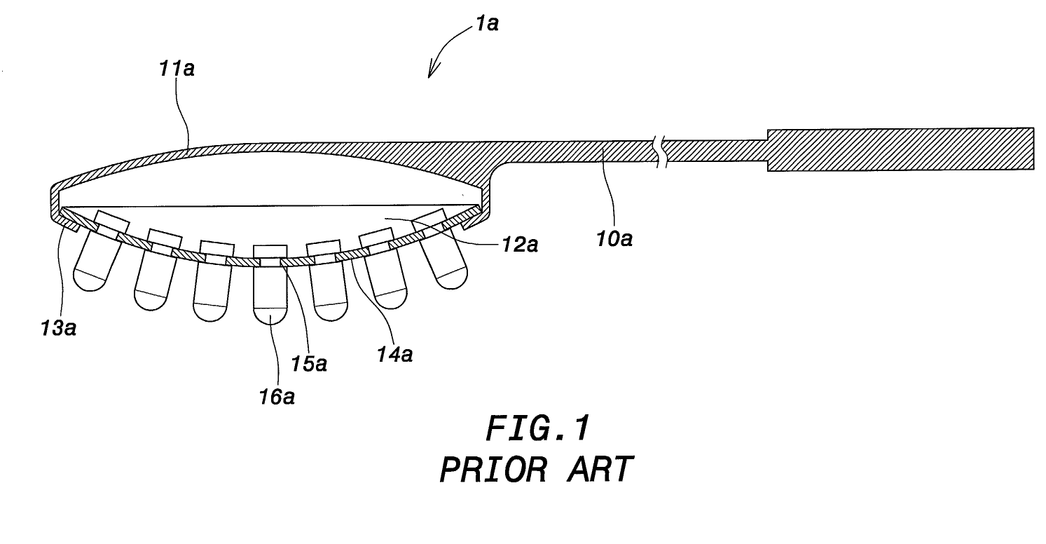

FIG. 2 is a schematic perspective view of the present invention.

FIG. 3 is an exploded cross sectional view of the present invention.

FIG. 4 is an assembled cross sectional view of the present invention.

FIG. 5 is a schematic perspective view of the connecting unit in the present invention.

FIG. 6 is a schematic view showing the use of the present invention.

FIG. 7 is a schematic perspective view of another embodiment in the present invention.

### DETAILED DESCRIPTION OF THE PREFERRED EMBODIMENTS

The various objects and advantages of the present invention will be more readily understood from the following detailed description when read in conjunction with the appended drawing.

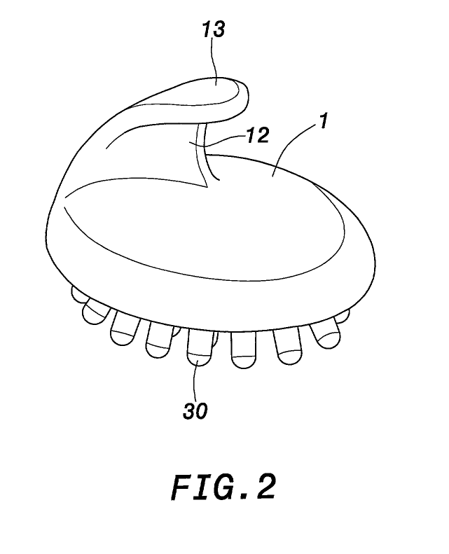

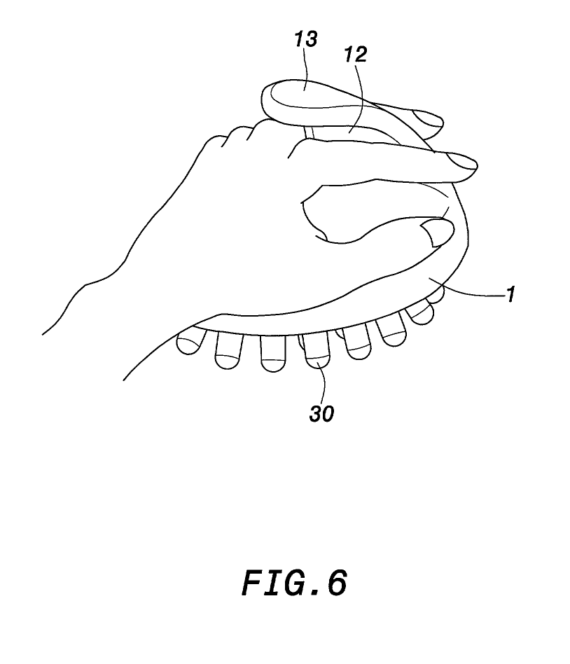

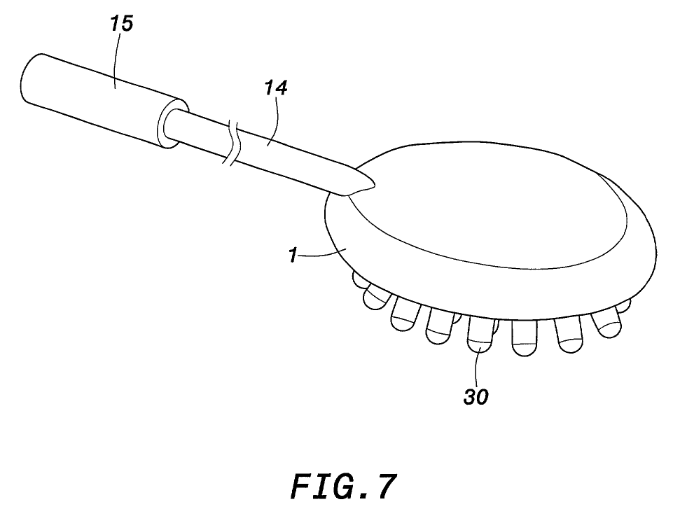

Referring to FIGS. 2, 3 and 4, the schematic perspective view, exploded cross sectional view, and assembled cross sectional view of the present invention are illustrated. The massage device of the present invention includes a housing 1, a connecting unit 2, and an elastomer 3. The lower end of the housing 1 is installed with a hollow recess 10. The inner wall of the recess 10 is installed with a circular groove 11. Furthermore, the top surface of the housing 1 is formed as a shape (not show) to be held by a hand matching the required of ergonomics. Or the top of the housing 1 is installed with a dual use a sheet 12 (referring to FIG. 6) capable of being clamping by two fingers. The top of the sheet 12 is integrally formed with a vertical top portion 13. Therefore, by clamping by two fingers or holding by a hand, the massage device can be held steadily so as to prevent the massage device from sliding down. Furthermore, a rod 14 can be installed (referring to FIG. 7). One end of the rod 14 is connected to the surface of the housing 1, while another end thereof is installed with a holding portion 15 for being held by a hand.

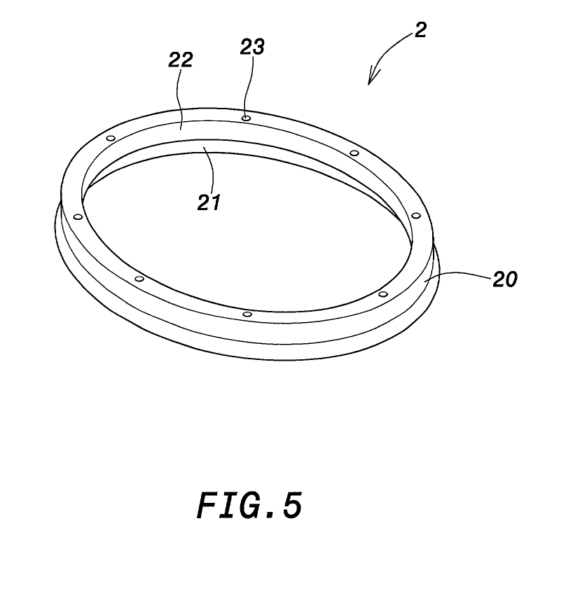

Referring to FIG. 5, the connecting unit 2 has an annular body having an outer wall 20 and an inner wall 21. The outer wall 20 of the connecting unit 2 is matchable with the groove 11 of the housing 1 so that the connecting unit 2 will steadily buckle to the lower edge of the housing 1. Alternatively, the outer wall 20 of the connecting unit 2 may be connected to the recess 10 by adhering with glue (not shown) or other ways. Therefore, it is unnecessary to form the groove 11 in the inner wall of the recess 10. Another, the connecting unit 2 can be formed as a round annular body, and outer thread (not shown) is installed to the outer wall 20 of the connecting unit 2. Furthermore, the matched inner thread 20 (not shown) can be installed to the inner wall of the recess 10. Thus, the two are screwedly together, the housing 1 being steadily secured to the connecting unit 2.

Furthermore, the inner wall 21 of the connecting unit 2 is installed with an annular trench 22, and a plurality of though holes 23 communicated with the trench 22 are installed at proper positions of the connecting unit 2. An opening 24 is installed in the trench 22. The bending portion 25 extended downwards is formed at the opening 24 near the inner wall 21 of the connecting unit 2. The bending portion 25 is reduced inwards so that the lower edge of the inner wall 21 of the connecting unit 2 bends inwards.

The elastomer 3 is an elastic piece made of resilient material, such as rubber and other soft material. The lower end of the elastomer 3 is formed with a plurality of protrusions 30. The protrusions 30 are integrally formed with the elastomer 3 (not shown). A plurality of apertures 31 is formed on the elastomer 3 and the protrusions 30 pass through respective apertures 31. Furthermore, the outer edge of the elastomer 3 is installed in the trench 22 of the connecting unit 2. The elastomer 3 can be clamped to the connecting unit 2 by the trench 22 and protrudes from the lower edge of the housing 1 so that the protrusions 30 are expanded. Then glue (not shown) is filled into the though hole 23 of the connecting unit 2 so as to tightly connect the elastomer 3 with the connecting unit 2.

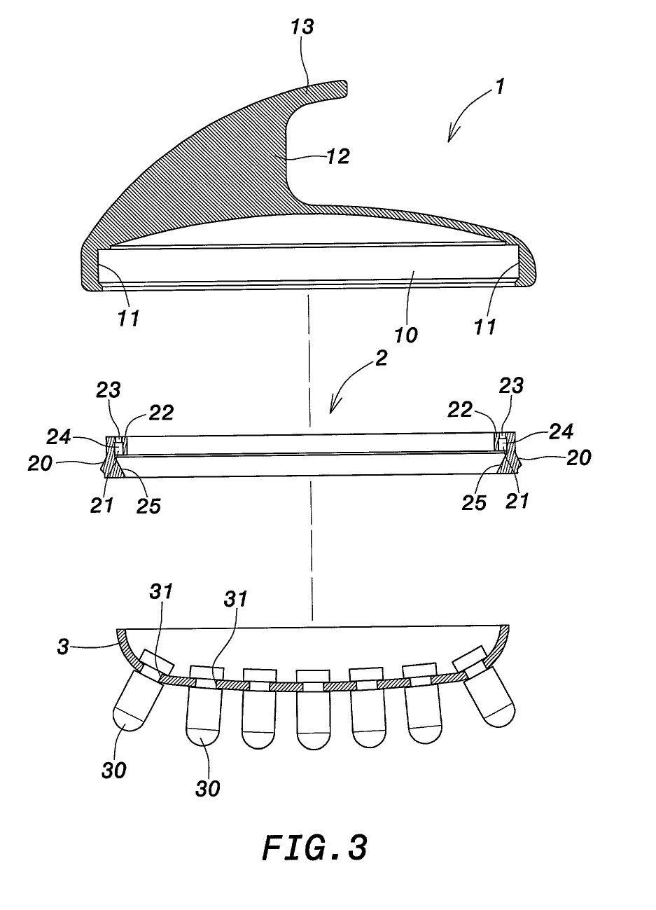

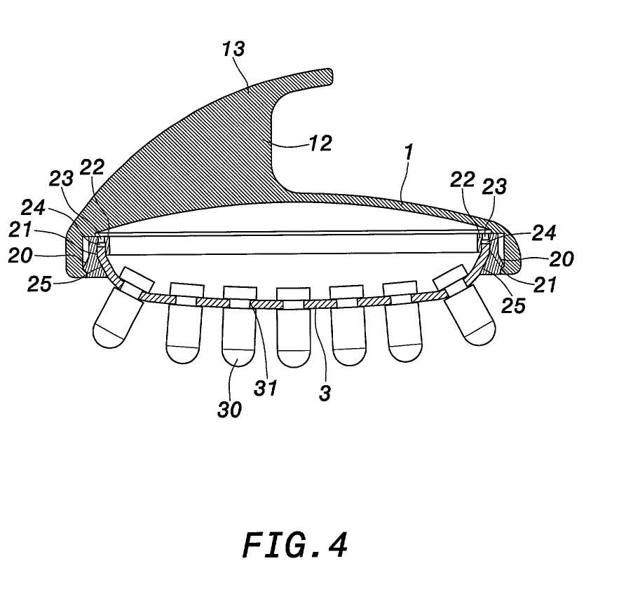

Referring to FIGS. 3 and 4, in assembling the present invention, the outer edge of the elastomer 3 is installed in the trench 22 of connecting unit 2 and then glue (not shown) is filled into the trench 22 of the though holes 23 so that the elastomer 3 and the connecting unit 2 are tightly connected by using glue (not shown). Therefore, the elastomer 3 is preferably combined with the connecting unit 2. The outer edge of the elastomer 3 will not separate with the connecting unit 2 due to a press force. Since the outer edge of the elastomer 3 is installed in the trench 22 to seal the opening 24, the sticky glue (not shown) will not flow out and thus the beautiful outlook will not affected. Moreover, since the connecting unit 2 is installed with a bending portion 25, the bottom of the elastomer 3 is tightly contacted with the inner wall 21 of the connecting unit 2. The elastomer 3 is enhanced to increase the massage effect.

Then, the connecting unit 2 is installed at the lower end of the housing 1, namely, the connecting unit 2 is buckled to the recess 10 of the housing 1. However, the connecting unit 2 can be rapidly and conveniently buckled to the housing 1, the outer wall 20 of the connecting unit 2 is formed with an downwards expanded annular surface (referring to FIG. 3). Therefore, the tilt surface at the outer edge of the groove 11 along the outer wall 20 of the connecting unit 2 is enlarged gradually until the connecting unit 2 is buckled. Therefore, by the aforesaid structure, the massage device of the present invention is formed.

Furthermore, the massage device of the present invention can be diversified and produced rapidly due to following reasons. 1. The housing 1 and the connecting unit 2 can be buckled rapidly, and thus after the specifications of the connecting unit 2 and the elastomer 3 are determined, the housings 1 of various shapes (referring to FIGS. 6 and 7) are made. Therefore, the assembling work is easily and rapidly.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A massage device comprising:
a housing with a recess at a lower end;
a connecting unit being an annular body, and having an outer wall which is engaged to an inner wall of the recess so as to be connected to the housing; the inner wall of the connecting unit being formed with a trench and being installed with a plurality of though holes communicated with the trench; and
an elastomer having a plurality of protrusions at an lower end thereof;
an outer edge of the elastomer being installed to the trench of the connecting unit; and the elastomer protruding out toward an lower end of the housing, thereby, glues being filled from the though holes of the connecting unit.

2. The massage device as claimed in claim 1, wherein a top surface of the housing is formed ergonomically with a shape to be easily held by a hand.

3. The massage device as claimed in claim 1, wherein the top end of the housing is installed with a sheet which is capable of being clamped by two fingers.

4. The massage device as claimed in claim 1, wherein a surface of the housing is connected to one end of a rod, and another end of the rod is installed with a holding portion to be held by a hand.

5. The massage device as claimed in claim 1, wherein the recess of the housing has an inner wall which is directly stuck to the outer wall of the connecting unit by gluing.

6. The massage device as claimed in claim 1, wherein the inner wall of the recess of the housing is formed with a groove and the outer wall of the connecting unit is coupled to the outer wall of the connecting unit so that the connecting unit is buckled to a bottom of the housing.

7. The massage device as claimed in claim 1, wherein the outer wall of the connecting unit is formed with a downward eapanding tilt surface.

8. The massage device as claimed in claim 1, wherein the outer wall of the connecting unit is formed with outer thread, and the inner wall of the recess of the housing is formed with matched inner thread, and thus, the two are connected by threading engagement.

9. The massage device as claimed in claim 1, wherein the trench of the connecting unit is formed with an opening, a bending portion is installed at the opening near the inner wall of the connecting unit, and the bending portion is inwards reduced so that the bottom of the inner wall of the connecting unit is bent inwards.

10. The massage device as claimed in claim 1, wherein the protrusion of the elastomer is integrally formed with the elastomer, or a plurality of apertures are firstly formed on the elastomer and then the protrusions passes through the apertures.
